(19) United States
(12) Patent Application Publication
(10) Pub. No.: US 2026/0148183 A1
(43) Pub. Date: May 28, 2026

(54) COMPUTING PRODUCT DIMENSIONS USING TEXT-BASED FEATURES

(71) Applicant: Walmart Apollo, LLC, Bentonville, AR (US)

(72) Inventors: Vikrant Tare, Dublin, CA (US); Ashwin Sattiraju, Pleasanton, CA (US)

(73) Assignee: Walmart Apollo, LLC, Bentonville, AR (US)

(21) Appl. No.: 18/957,127

(22) Filed: Nov. 22, 2024

(51) Int. Cl. G06Q 10/087

(52) U.S. Cl. CPC G06Q 10/087

(57) ABSTRACT

A method can include computing, a dimension of a product using a machine learning model, a dimension of a product. The computing can include, transforming preprocessed data into numerical values using a vectorize layer. The computing can also include, condensing the numerical values using an embedding layer. The predicting can further include, processing the numerical values, as condensed, using a global average pooling layer. The predicting can also include, concatenating the numerical values, as processed into a layer. The predicting can further include processing the layer using a first dense layer. The predicting can additionally include, standardizing the layer, as processed, using a batch normalization layer. The predicting can also include, transforming the layer, as standardized, using an activation function. The predicting can additionally include, regularizing the layer, as transformed, using a dropout function. The predicting can further include, outputting the dimension of the product, with an output layer. Other embodiments are described.

### FIELD OF THE DISCLOSURE

The present disclosure generally relates to predicting product dimensions using text-based features.

### BACKGROUND

Product dimensions may be measured by automated dimensioning machines. Product dimensions may be used in shipping logistics, stock availability, fulfillment costs, and return policies.

### BRIEF DESCRIPTION OF THE DRAWINGS

The figures described below depict various aspects of the systems, methods, and non-transitory computer readable storage media disclosed therein. It should be understood that each figure depicts an embodiment of a particular aspect of the disclosed systems, methods, and non-transitory computer readable storage media, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of two computer systems that are suitable for implementing an embodiment of the system disclosed in FIG. 4;

FIG. 2 illustrates a representative block diagram of an example of the elements included in the circuit boards inside a chassis of the computer systems of FIG. 1;

FIG. 3 illustrates an example architecture of the machine learning model, according to one embodiment;

FIG. 4 illustrates a system for predicting product dimensions using text-based features, according to one embodiment; and

FIG. 5 illustrates a flow chart for a method of predicting product dimensions using text-based features, according to one embodiment.

The figures depict embodiments for purposes of illustration only. One skilled in the art will readily recognize from the following discussion that other embodiments of the systems, methods, and non-transitory computer-readable media storing computing instructions that are described herein can be employed without departing from the principles of the technology described herein.

### DETAILED DESCRIPTION

Product dimensions such as in a product catalog may be subject to inaccuracies and errors. Inaccurate product dimensions can stem from errors in initial measurements/remeasurements, typographical errors, and the sensitivity of automated measuring machines. Inaccurate product dimensions present challenges in shipping logistics, stock availability, fulfillment costs, and return policies. Inaccurate product dimensions impact (a) determining the kind of fulfilment center used to fulfill the order (for example, small items are sortable while large items are non-sortable), (b) determining the carrier method for outbound shipment, and (c) accuracy of the information of the item displayed on a website or online catalog offering the item for sale. A system and method for addressing the impact of inaccurate product dimensions is desired.

The present embodiments can generally relate to predicting product dimensions using text-based features, such as product name, a product description, a brand name, a product type, etc. More specifically, various embodiments can include a method including predicting, using a machine learning model, a dimension of a product. The predicting can include, transforming preprocessed data into numerical values by at least using a vectorize layer. The predicting can also include, concatenating the numerical values into a layer. The predicting can further include processing the layer using a first dense layer. The predicting can additionally include, standardizing the layer, as processed, using a batch normalization layer. The predicting can also include, transforming the layer, as standardized, with an activation function. The predicting can further include, outputting the dimension of the product, as predicted, with an output layer.

Other embodiments can include a non-transitory computer-readable medium storing computing instructions that, when executed on a processor, cause the processor to perform operations. The operations can include predicting, using a machine learning model, a dimension of a product. The predicting can include, transforming preprocessed data into numerical values by at least using a vectorize layer. The predicting can also include, concatenating the numerical values into a layer. The predicting can further include processing the layer using a first dense layer. The predicting can additionally include, standardizing the layer, as processed, using a batch normalization layer. The predicting can also include, transforming the layer, as standardized, with an activation function. The predicting can further include, outputting the dimension of the product, as predicted, with an output layer.

In other embodiments, a system can be provided. The system can include one or more local or remote processors or servers, mobile devices, smart glasses including augmented reality glasses, virtual reality headsets, mixed or extended reality headsets, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, direct the one or more processors to perform one or more operations. The operations can include predicting, using a machine learning model, a dimension of a product. The predicting can include, transforming preprocessed data into numerical values by at least using a vectorize layer. The predicting can also include, concatenating the numerical values into a layer. The predicting can further include processing the layer using a first dense layer. The predicting can additionally include, standardizing the layer, as processed, using a batch normalization layer. The predicting can also include, transforming the layer, as standardized, with an activation function. The predicting can further include, outputting the dimension of the product, as predicted, with an output layer.

Advantages will become more apparent to those skilled in the art from the following description of the embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

In some embodiments, the methods, systems, and non-transitory computer readable storage media can be used to more accurately determine the product dimension by accommodating multiple inputs with the use of multiple input layers. In some embodiments, the methods, systems, and non-transitory computer readable storage media can use a global average pooling layer, which averages the output of each feature map in the preceding layer to reduce the spatial dimensions of the input without losing content information. In some embodiments, the methods, systems, and non-transitory computer readable storage media can have multiple output layers, each generating a separate prediction, making it advantageous for maki multi-output predictions.

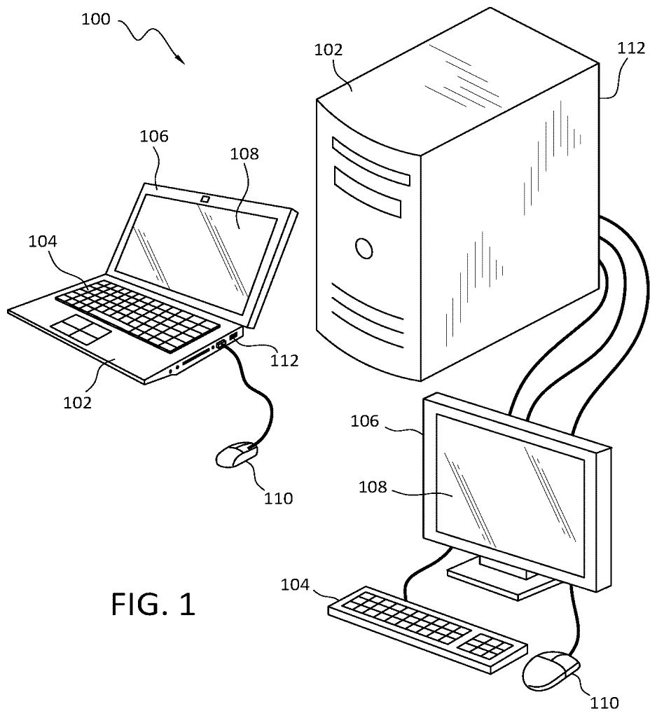

Turning to the drawings, FIG. 1 illustrates an embodiment of two different types (e.g., a laptop and a tower server) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

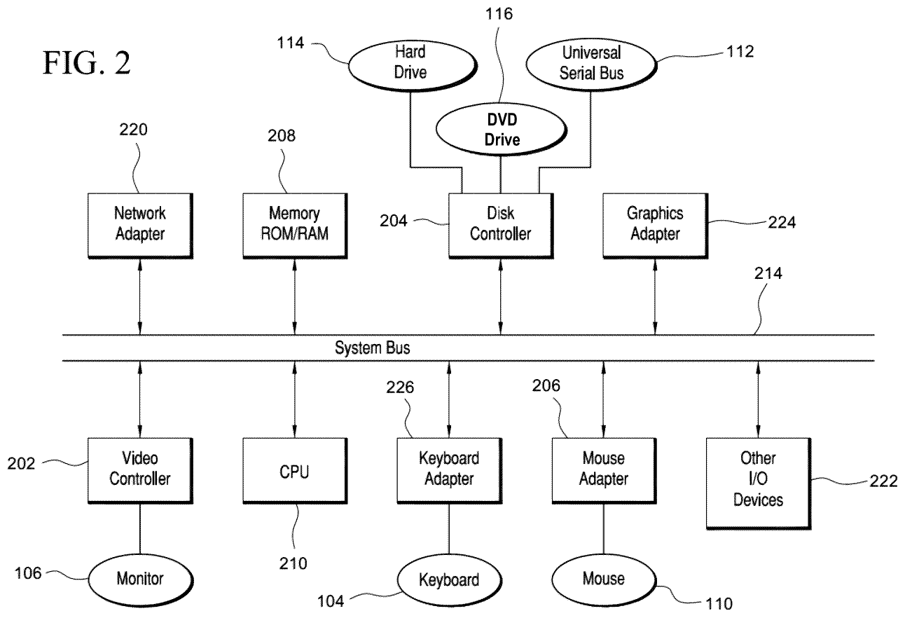

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS by The Open Group Ltd. of Reading, Berkshire in the United Kingdom, and (iv) Linux® OS by Linus Torvalds of Boston, Massachusetts, United State of America.

Further operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O (input/output) devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well-known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer or a tower server in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, a virtual reality headset, augmented reality glasses, etc. In certain additional embodiments, computer system 100 can comprise an embedded system.

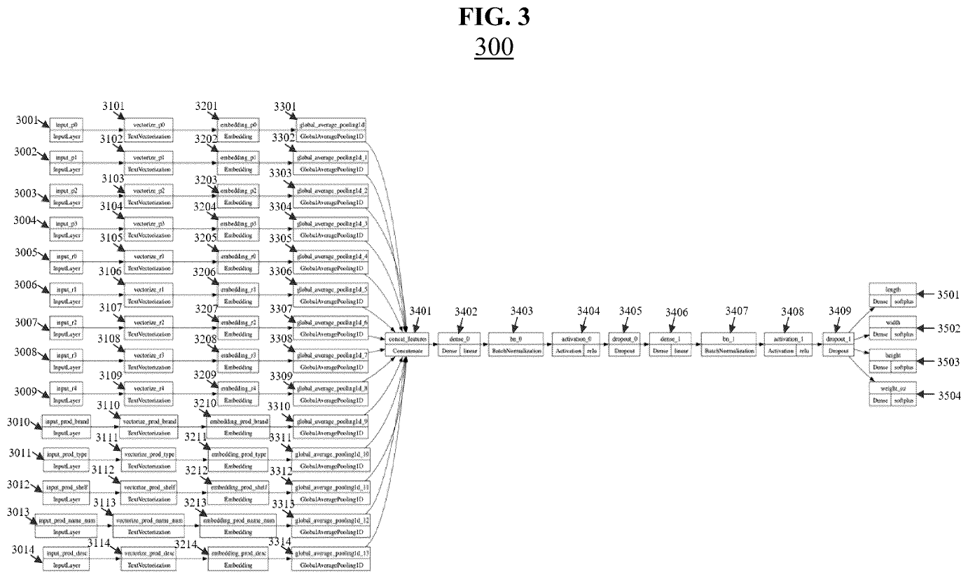

Turning ahead in the drawings, FIG. 3 illustrates an example architecture of the machine learning model 300, according to various embodiments. Machine learning model 300 is an example, and embodiments of the system are not limited to the embodiments presented herein. The machine learning model 300 can be employed in many different embodiments or examples not specifically depicted or described herein. In some embodiments, certain elements, modules, or systems of machine learning model 300 can perform various procedures, processes, operations, actions, and/or activities. In other embodiments, the procedures, processes, operations, actions, and/or activities can be performed by other suitable elements, modules, or systems of machine learning model 300. The machine learning model 300 can be deployed on a model deployment as a service (MDaaS) to allow the model to serve predictions. The model can be loaded from a cloud storage. Once deployed, an API (application programming interface) can be used to interact with the model and obtain predictions.

The inputs of the example layers p0 input layer 3001, p1 input layer 3002, p2 input layer 3003, p3 input layer 3004, r0 input layer 3005, r1 input layer 3006, r2 input layer 3007, r3 input layer 3008, r4 input layer 3009, brand input layer 3010, product type input layer 3011, product shelf input layer 3012, product name and number input layer 3013, and product description input layer 3014 can include pre-processed data that is gathered from multiple sources and checked for items that have received a quantity greater than 0 to be sure that the most updated dataset is fed into the model. Each input layer (e.g., p0 input layer 3001, p1 input layer 3002, p2 input layer 3003, p3 input layer 3004, r0 input layer 3005, r1 input layer 3006, r2 input layer 3007, r3 input layer 3008, r4 input layer 3009, brand input layer 3010, product type input layer 3011, product shelf input layer 3012, product name and number input layer 3013, and product description input layer 3014 can comprise a shape of (1,) and the data type of string. Input data can be stored in a cloud database, a local or remote database, or a spreadsheet. The input data can be preprocessed before being inputted into the machine learning model. The preprocess can be performed with algorithms such as Spark™ compute or another data analysis platform, and the preprocessed dataset can be stored in a cloud database. The pre-processing pipeline is explained in detail herein.

The inputs of p0 input layer 3001, p1 input layer 3002, p2 input layer 3003, and p3 input layer 3004 can refer to a classification on the store website. For example, the inputs of p0 input layer 3001, p1 input layer 3002, p2 input layer 3003, and p3 input layer 3004 for a lava lamp can be “home, decor, fixtures lighting light, novelty lights”, respectively.

The inputs of r0 input layer 3005, r1 input layer 3006, r2 input layer 3007, r3 input layer 3008, r4 input layer 3009 can refer to a reporting hierarchy (e.g. financial reports). For example, the inputs of r0 input layer 3005, r1 input layer 3006, r2 input layer 3007, r3 input layer 3008, r4 input layer 3009 for a lava lamp can be “home, home decor, lighting, novelty lighting, lamps lava”, respectively.

In some embodiments, machine learning model 300 can comprise of p0 input layer 3001, p1 input layer 3002, p2 input layer 3003, and/or p3 input layer 3004 without comprising r0 input layer 3005, r1 input layer 3006, r2 input layer 3007, r3 input layer 3008, and/or r4 input layer 3009. In other embodiments, machine learning model 300 can comprise of r0 input layer 3005, r1 input layer 3006, r2 input layer 3007, r3 input layer 3008, and/or r4 input layer 3009 without comprising p0 input layer 3001, p1 input layer 3002, p2 input layer 3003, and/or p3 input layer 3004.

Brand input layer 3010 can receive a name of a brand, product type input layer 3011 can receive one or more product types, product shelf input layer 3012 can receive the shelf location the product can be located at, product name and number input layer 3013 can receive the name of the product and the product number, and product description input layer 3014 can receive the description of the product. For example, for a lava lamp, the brand can be “LAVA®” and the product type can be “decorative lighting product” Product name and number input layer 3013 can receive the product name of the product, including nouns, proper nouns, and adjectives. Product description input layer 3014 can receive the product description of the product including nouns, proper nouns, and adjectives. For example, the input of product description input layer 3014 for a lava lamp can be “room happy place relaxation adult thrilled adults quality calming lava lamp buy shape motion durable liquid molten classical beautiful timeless gift pink year amazed material construction ambience magical workmanship piece confidence child jambo wonderful mesmerizing great day colored light wonderland stunning soothing multi relaxing perfect purple word engaging wax warranty high mindfulness enhance.”

P0 vectorization layer 3101, p1 vectorization layer 3102, p2 vectorization layer 3103, p3 vectorization layer 3104, r0 vectorization layer 3105, r1 vectorization layer 3106, r2 vectorization layer 3107, r3 vectorization layer 3108, r4 vectorization layer 3109, brand vectorization layer 3110, product type vectorization layer 3111, product shelf vectorization layer 3112, product name and number vectorization layer 3113, and product description vectorization layer 3114 can receive a respective input, which is a respective output from their respective input layer (e.g., p0 input layer 3001, p1 input layer 3002, p2 input layer 3003, p3 input layer 3004, r0 input layer 3005, r1 input layer 3006, r2 input layer 3007, r3 input layer 3008, r4 input layer 3009, brand input layer 3010, product type input layer 3011, product shelf input layer 3012, product name and number input layer 3013, and product description input layer 3014) These vectorization layers convert the text data into a numerical format that can be used by the neural network.

P0 embedding layer 3201, p1 embedding layer 3202, p2 embedding layer 3203, p3 embedding layer 3204, r0 embedding layer 3205, r1 embedding layer 3206, r2 embedding layer 3207, r3 embedding layer 3208, r4 embedding layer 3209, brand embedding layer 3210, product type embedding layer 3211, product shelf embedding layer 3212, product name and number embedding layer 3213, and product description embedding layer 3214 can receive a respective input, which is a respective output from their respective vectorization layer (e.g. p0 vectorization layer 3101, p1 vectorization layer 3102, p2 vectorization layer 3103, p3 vectorization layer 3104, r0 vectorization layer 3105, r1 vectorization layer 3106, r2 vectorization layer 3107, r3 vectorization layer 3108, r4 vectorization layer 3109, brand vectorization layer 3110, product type vectorization layer 3111, product shelf vectorization layer 3112, product name and number vectorization layer 3113, and product description vectorization layer 3114). The embedding layers condense the data that is in numerical format. For example, integers can be converted into floating values.

Global average pooling layers 3301-3314 can receive a respective input, which is a respective output from their respective embedding layer (P0 embedding layer 3201, p1 embedding layer 3202, p2 embedding layer 3203, p3 embedding layer 3204, r0 embedding layer 3205, r1 embedding layer 3206, r2 embedding layer 3207, r3 embedding layer 3208, r4 embedding layer 3209, brand embedding layer 3210, product type embedding layer 3211, product shelf embedding layer 3212, product name and number embedding layer 3213, and product description embedding layer 3214). The global average pooling layers 3301-3314 simplifies the dimensions (output) of their respective embedding layers.

Concatenation layer 3401 receives inputs, which are the outputs from the global average pooling layers 3301-3314 and concatenates the inputs into a single layer using a “Concatenate” function. Concatenation layer 3401 creates a denser representation of the inputs.

The output of concatenation layer 3401 is passed through hidden layers comprising several dense layers (e.g., first dense layer 3402 and second dense layer 3406) that are fully connected neural network layers. The quantity of dense layers can vary depending on a variety of factors, including the specific number of neurons in each dense layer. Each dense layer can not use bias and can be initialized with a specific kernal initializer (e.g. he_normal).

Each dense layer (e.g., first dense layer 3402 and second dense layer 3406) can be followed by a respective batch normalization layer (e.g., first batch normalization layer 3403 and second batch normalization layer 3407). The batch normalization layers standardize the inputs for the activation function(s) (e.g., first activation function 3404 and second activation function 3408). The batch normalization layers can improve the speed, performance, and stability of the neural network.

The activation function(s) (e.g., first activation function 3404 and second activation function 3408) can be applied to the output(s) of the batch normalization layer(s) (e.g., first batch normalization layer 3403 and second batch normalization layer 3407). Each activation function can be a rectified linear unit (ReLU) activation function.

In some embodiments, each activation function (e.g., first activation function 3404 and second activation function 3408) can be followed by a respective dropout function (e.g. first dropout function 3405 and second dropout function 3409). The dropout function prevents overfitting to improve model efficiency.

The output layer of machine learning model 300 can comprise length output 3501, width output 3502, height output 3503, and weight output 3504. For example, the output layer can receive as an input, the output of second dropout function 3409, in one embodiment according to FIG. 3. Each output layer (length output 3501, width output 3502, height output 3503, and weight output 3504) can comprise a dense layer that can comprise a single neuron for each output. Each output specifies the predicted length, width, height, and weight of the product. In some embodiments, the output layer can comprise a softplus activation layer. Among other things, the softplus activation layer can ensure that each output layer (length output 3501, width output 3502, height output 3503, and weight output 3504) outputs positive values.

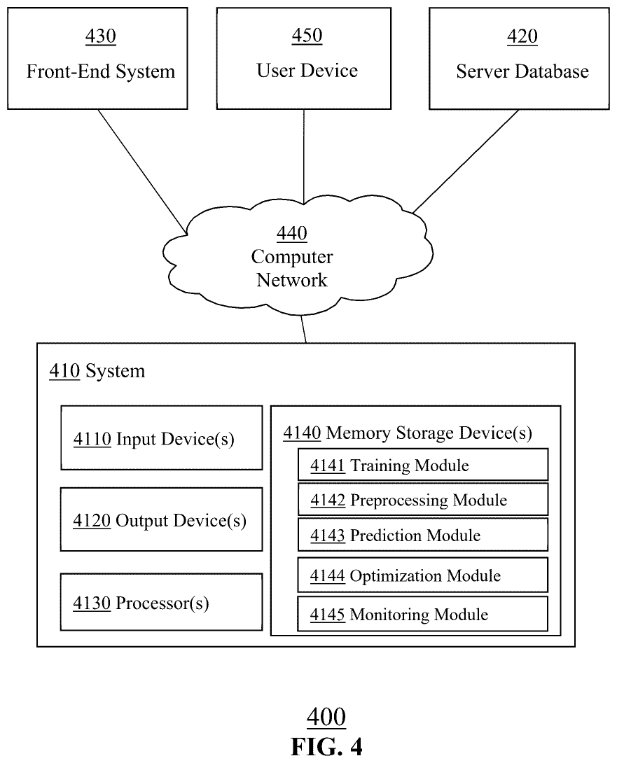

Turning ahead in the drawings, FIG. 4 illustrates a block diagram of a System 400 for predicting product dimensions using text-based features, according to various embodiments. System 400 can comprise machine learning model 300 (FIG. 3). System 400 is an example, and embodiments of the system are not limited to the embodiments presented herein. The System can be employed in many different embodiments or examples not specifically depicted or described herein. In some embodiments, certain elements, modules, or systems of System 400 can perform various procedures, processes, operations, actions, and/or activities. In other embodiments, the procedures, processes, operations, actions, and/or activities can be performed by other suitable elements, modules, or systems of System 400.

Generally, System 400 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of System 400 described herein.

In some embodiments, System 400 can include a Server Database 420 and a System 410. In the same or different embodiments, System 400 also can include a Front-End System 430, a Computer Network 440, and a User Device 450.

In some embodiments, each of System 410, Server Database 420, Front-End System 430, and User Device 450 can include modules (such as training module 4141, preprocessing module 4142, prediction module 4143, optimization module 4144, and/or monitoring module 4145, as described further herein below) which may include computing instructions stored on non-transitory computer readable media and executable by one or more processors or may, in addition or as an alternative, include a hardware device comprising electronic circuitry for implementing the functionality described below. In other embodiments, each of System 410, Server Database 420, Front-End System 430, and User Device 450 can be implemented in hardware, including ASICs (application specific integrated circuits) and the like.

In some embodiments, System 410 can comprise one or more systems, subsystems, modules, models, or servers (e.g., machine learning model 300.). Machine learning model 300 can be implemented, at least in part, in software and/or firmware stored in or loaded on an internal or remote memory storage device(s) of System 410 and executed on a processor of System 410. In various embodiments, one or more of System 410, Front End System 430, User Device 450, and Server Database 420 can include one or more of trained machine learning (ML) and/or artificial intelligence (AI) models (the ML/AI models). Each of System 410, Front End System 430, User Device 450, and Server Database 420 can be a standard component or a custom component used to implement a portion of the system, method, and/or non-transitory computer-readable medium, as described herein. Additional details regarding System 410, Front End System 430, User Device 450, and Server Database 420 are described herein.

In some embodiments, each of System 410, Server Database 420, Front-End System 430, and User Device 450 can be in data communication, through a computer network, a telephone network, or the Internet (e.g., Computer Network 440) with each other. In other embodiments, System 410, Server Database 420, Front-End System 430, and User Device 450 are in direct communication with each other using, for example, Bluetooth communication.

In some embodiments, each of System 410, Server Database 420, Front-End System 430, and User Device 450 can include one or more input devices, one or more output devices, one or more processors, and/or one or more memory storage devices. Examples of input devices can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output devices can include one or more monitors, one or more touch screen displays, projectors, monitor 106 (FIG. 1), screen 108 (FIG. 1), etc. Other examples of output devices can include other I/O device 222 (FIG. 2), network adapter 220, wireless transmitters, wired transmitters, and the like. Examples of processors can include CPU 210 (FIG. 2), etc. Examples of memory storage devices can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input devices further can include one or more cameras and/or one or more microphones. In the same or different embodiments, input devices can include one or more GPS (Global Positioning System) sensor(s), one or more accelerometers, and/or one or more gyroscopes.

Input devices and output devices can be coupled to their respective System 410, Server Database 420, Front-End System 430, and User Device 450 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple an input device and an output device to a processor and/or a memory storage device, all of a particular user device. In a similar manner, the processors and/or memory storage devices of the user devices can be local and/or remote to each other.

In certain embodiments, User Device 450 can be one or more mobile devices, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, other smart jewelry, augmented-reality (AR) headsets, virtual-reality (VR) headsets, etc.), or another portable computer device with the capability to present audio and/or visual data (e.g., images, videos, music, etc.).

Mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Mayada, (iii) a Lumia® or similar product by the Nokia Corporation of Keilaniemi, Espoo, Finland, or (iv) a Galaxy™ Tab or Smartphone or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Mayada, (iii) the Android™ operating system developed by the Open Handset Alliance, or (iv) the Windows Mobile™ operating system by Microsoft Corp. of Redmond, Washington, United States of America.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communications between one or more of System 410, Server Database 420, Front-End System 430, and User Device 450 can be implemented using any suitable manner of wired and/or wireless communication. Accordingly, System 410, Server Database 420, Front-End System 430, and User Device 450 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). PAN protocol(s) can include Bluetooth, Zigbee, Wireless Universal Serial Bus (USB), Z-Wave, etc. ; LAN and/or WAN protocol(s) can include Institute of Electrical and Electronic Engineers (IEEE) 802.3 (also known as Ethernet), IEEE 802.11 (also known as WiFi), etc. ; and wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In some embodiments, communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further communication hardware can include wireless communication hardware including, for example, one or more radio transceivers, one or more infrared transceivers, etc. Additional communication hardware can include one or more networking components (e.g., modulator-demodulator components, gateway components, etc.).

In some embodiments, System 410 can be configured to transmit to a User Device 450 of a user, or to a graphical user interface (e.g., a webpage, a graphical user interface of a mobile application, etc.) for display on the user device. System 410, Server Database 420, Front-End System 430, and User Device 450 can determine, by using any suitable approaches or ML/AI models, the statistics, notices, augmented reality views, feedback, and other information. Algorithms for the ML/AI models for determining the information can include decision trees, K Nearest Neighbor (KNN), neural networks, CatBoost, support vector machine, etc.

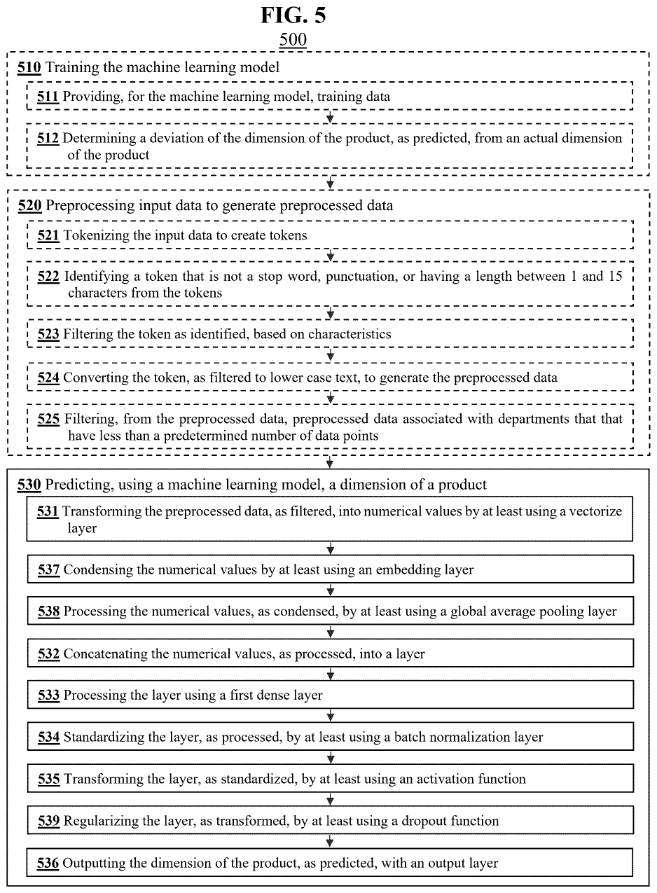

Turning ahead in the drawings, FIG. 5 illustrates a flow chart for a method 500 for predicting product dimensions using text-based features, according to one embodiment. Method 500 can be implemented via execution of computing instructions configured to run on one or more processors and stored on one or more non-transitory computer-readable media, and/or via one or more ASICs. Method 500 is merely an example and is not limited to the embodiments presented herein. Method 500 can be employed in many different embodiments or examples not specifically depicted or described herein.

In some embodiments, the procedures, the processes, the operations, the actions, and/or the activities of method 500 can be performed in the order presented. In other embodiments, the procedures, the processes, the operations, the actions, and/or the activities of method 500 can be performed in any suitable order. In still other embodiments, one or more of the procedures, the processes, the operations, the actions, and/or the activities of method 500 can be combined together or skipped.

In some embodiments, System 410 (FIG. 4) can be suitable to perform method 500 and/or one or more of the operations, actions, and/or activities of method 500. In these or other embodiments, one or more of the operations, actions, and/or activities of method 500 can be implemented as one or more computing instructions configured to run on one or more processors and configured to be stored on one or more non-transitory computer readable media, and/or as one or more ASICs. Such non-transitory computer readable media can be part of a computer system such as System 410, Server Database 420, Front-End System 430, and User Device 450. The processor(s) can be similar or identical to the processor(s) described above with respect to computer system 100 (FIG. 1).

Referring to FIG. 5, in some embodiments, method 500 can include a block 510 of training the machine learning model.

Block 510 can include a block 511 of providing, for the machine learning model, training data. The provided training data can be measurement data measured by a single retailer to ensure consistency and accuracy in the measurement of dimensions (width, length, height, and weight). In some implementations, measurement data of third party sellers may be excluded due to the possibility of inaccuracies and inconsistencies as third party sellers are numerous and may not use a standardized equipment. The training data can include data for one or more products and the data for one or more products can include a product name, a product description, a brand name, a product type, a product taxonomy, a numerical feature, or a product path. The training input data can also include the actual dimensions including an actual length, an actual width, an actual height, and/or an actual weight. Other details included can a product's global trade item number (GTIN), the received quantity, and/or a super department. The input data of a product having its dimensions being predicted can comprise of the same details as the training input data. The machine learning model can comprise a feedforward neural network (FNN).

Block 510 can further include a block 512 of determining a deviation of the dimension of the product, as predicted, from an actual dimension of the product. Each output of a model may have a performance metric and loss function. The Mean Absolute Error (MAE) and Mean Absolute Percentage Error (MAPE) can be calculated (for each input) and indicate how much of the model's predictions deviate from the actual values on average in absolute terms and as a percentage, respectively. The loss function for outputs uses the Mean Absolute Error (MAE) as the loss function. The MAE is a common regression loss function that calculates the average absolute difference between the predicted and actual values.

In some embodiments, the use of the common regression loss function provides the technical advantage of providing improved results over convention methods by improved detection of outliers to provide more accurate results over convention methods. Further, in some embodiments, an Adam optimizer can be used to optimize the loss function and improve the model. The Adam optimizer is an algorithm for first-order gradient-based optimization of stochastic objection functions.

In some embodiments, callbacks can be used. For example, ‘model_early_stop’ stops training when a monitored metric has stopped improving, which prevents overfitting. ‘Model_checkpoint’ saves the model after every epoch. ‘PrintValidationLoss’ prints the validation loss after each epoch. A batch size of 256 can be used for building models, according to some embodiments. In some embodiments, the model weights and prediction cache file(s) can be stored in a cloud. The model weights of different model versions can be compared in order to perform historical analysis making adjustments to the model or model improvement.

Continuing with FIG. 5, in some embodiments, method 500 can include a block 520 of preprocessing input data to generate preprocessed data. Preprocessing the data can clean and extract valuable information from the input data. Basic pre-processing tasks such as removing HTML tags, URLs, newline and null characters, and extra white spaces can be performed.

Block 520 can further include a block 521 of tokenizing the input data to create tokens. Block 520 can further include a block 522 of identifying, from among the tokens created at block 521, a token that is not a stop word, is punctuation, or having a length between two predetermined character lengths (e.g. 1 and 15 characters). Block 520 can further include a block 523 of filtering the token as identified, based on characteristics at block 522. Block 520 can further include a block 524 of converting the token, as filtered to lower case text, to generate the preprocessed data. Block 520 can further include a block 525 of filtering, from the preprocessed data generated at block 524, preprocessed data associated with departments (e.g. grocery, health and wellness, electronics, home and furniture, clothing, toys, automotive, sports and outdoors, beauty, pet supplies, etc.) that that have less than a predetermined number of data points. This preprocessing removes data from departments that have less than the required amount of data points. Additionally, an outlier filter can be applied to remove extreme outliers that exist so that most (e.g., 99%, 90%, 75%, 67%, or 51%) of the data may be used. This preprocessed data can now be inputted into the input layer of the model or stored in a database, cloud, or spreadsheet.

Continuing with FIG. 5, in some embodiments, method 500 can include a block 530 of predicting, using a machine learning model, a dimension of a product.

Block 530 can include a block 531 of transforming the preprocessed data into numerical values by at least using a vectorize layer. This transformation allows the data to be used by the neural network.

Block 530 can include a block 537 of condensing the numerical values by at least using an embedding layer. Implementing the embedding layer at the feature level provides an advantage over implementing cross-feature embedding as feature-level embedding, by mapping individual features into a lower-dimensional space (text), capturing the relationships between different values of a single feature, compared to cross-feature embeddings, wherein interactions between different features are captured.

Block 530 can include a block 538 of processing the numerical values, as condensed at block 537, by at least using a global average pooling layer.

Block 530 can further include a block 532 of concatenating the numerical values into a layer. This creates a denser representation of the input data.

Block 530 can further include a block 533 of processing the layer using a first dense layer. Block 530 can further include a block 534 of standardizing the layer, as processed, using a batch normalization layer. Block 530 can further include a block 535 of transforming the layer, as standardized, with an activation function. Block 530 can include a block 539 of regularizing the layer, as transformed at block 535, by at least using a dropout function. Block 530 can further include a block 536 of outputting the dimension of the product, as predicted, with an output layer. In some embodiments, there can exist multiple dense layers, normalization layers, and activation functions that follow after the (first) activation function, similar to what is shown and described with reference to FIG. 3. Referring back to FIG. 5, the dimensions of the product outputted in block 536 can include a predicted length, a predicted width, a predicted height, and/or a predicted weight.

In a number of embodiments where one or more ML/AI models are used further can include pre-training and/or re-training the trained ML/AI models based upon the feedback received from a system user or collected from various data sources, and/or synthesized training data. In these embodiments, the same or different ML/AI models can be used in one or more of the above-referenced blocks.

For each of the machine learning models to be retrained, the respective training datasets can be updated manually by a system user (e.g., an ML engineer, a data scientist, etc.) and/or automatically by a system (e.g., System 410 (FIG. 4)). The system user can select new training data from various data sources. The system can collect new training data based upon various criteria. In certain embodiments, historical input and/or output data of the model to be re-trained can be used for re-training the model. In several embodiments, the historical input and/or output data of the model can be selected based upon system performance and/or user feedback from the system user associated with the historical output data. In various embodiments, when more than one training dataset is used for the pre-training and/or re-training, the system (e.g., System 410 (FIG. 4)) can format or re-format the data of the more than one training dataset (especially when datasets are from different sources) so that the hierarchy, schema, and/or other aspects of the data of the more than one training dataset follow a common hierarchy, structure, schema, etc., and so that the data of the more than one training dataset can be more easily used to pre-train or re-train the one or more machine learning models. The system can pre-determine the common hierarchy, structure, schema, etc. As needed, the system can reformat the data from various training dataset into a common data format so that the data can be used properly and efficiently by the system.

In some embodiments, the machine learning models, AI algorithms, classifiers, etc. can be customized and/or fine-tuned for the user. For example, the customized classifiers can be stored locally on System 410 (FIG. 4). As another example, one or more of these customized classifiers can be trained and/or retrained remotely and stored locally (e.g., at System 410 (FIG. 4)).

Examples of the algorithms used for the various ML/AI models for one or more of the above-mentioned procedures, processes, activities, actions, operations, and/or methods can include BERT (Bidirectional Encoder Representations from Transformers), LLM (Language Learning Models), Lambda, Palm, XLNet, GPT-3 (generative pre-training transformer), GPT-4, KNN (k-nearest neighbor), decision trees, linear regression, logistic regression, K-Means, neural networks, fuzzy logic, GANs (generative adversarial networks), CTGAN (cloud transformer generative adversarial networks), CNNs (convolutional neural networks), VAEs (variational autoencoder), and so forth. In various embodiments, each of the ML/AI models used can be trained and/or retrained dynamically and/or regularly.

In some embodiments, the systems and/or methods can be configured to train or re-train the one or more ML/AI models. The training of each of the ML/AI models can be supervised, semi-supervised, and/or unsupervised—which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In some embodiments, the trained and/or re-trained ML/AI model as well as the training datasets can be stored in, updated, and accessed from a database. In the same or different embodiments, when more than one training dataset is used for the pre-training and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pre-train or re-train the one or more machine learning models. In some embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback and/or predetermined criteria. The user feedback can be associated with the output data of the ML/AI models or the output of the systems and/or methods using the ML/AI models.

Relating FIG. 5 to FIG. 4, as an example, training module 4141 (FIG. 4) can perform block 510, including blocks 511 and 512; preprocessing module 4142 (FIG. 4) can perform block 520, including blocks 521-525; prediction module 4143 (FIG. 4) can perform block 530, including 531-536; optimization module 4144 (FIG. 4) can perform optimization of the loss function and improve the machine learning model 300 (FIG. 3); and monitoring module 4145 (FIG. 4) can perform monitoring of a performance of the processor and a memory usage of the system which the machine learning model 300 (FIG. 3) is deployed on and providing alerts when predetermined thresholds are reached for the performance of the usage of the processor and usage of the memory for machine learning model 300 (FIG. 3).

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

In some embodiments, the performance of the system which the machine learning model 300 (FIG. 3) is deployed on can be monitored. For example, a memory usage and a processor usage of the system which the machine learning model 300 (FIG. 3) is deployed on can be monitored. An alert can be transmitted when the memory usage and/or the processor usage of the system which the machine learning model 300 (FIG. 3) is deployed on exceeds a respective usage threshold. In some embodiments, an hourly scheduler can be used to predict new items to be predicted.

Although systems and methods for collecting data have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting. For example, the systems, methods, and non-transitory computer readable storage media disclosed herein can predict the dimension(s) of a product. In other use cases, the systems, methods, and non-transitory computer readable storage media disclosed herein can train the machine learning model for predicting the dimension(s) of a product. In further use cases, the systems, methods, and non-transitory computer readable storage media disclosed herein can preprocess the input data to be used for the predicting of the dimension(s) of a product.

It is intended that the scope of the disclosure shall be limited only to the extent required by the appended claims. For example, to one of ordinary skill in the art, it will be readily apparent that any element of FIGS. 1-5 can be modified, and that the foregoing discussion of certain of these embodiments does not necessarily represent a complete description of all possible embodiments. Additionally, one or more of the procedures, processes, operations, actions, and/or activities of the method in FIG. 5 can include different procedures, processes, actions, and/or activities and be performed by many different modules, in many different orders. As an example, the modules, models, elements, and/or systems within System 400 in FIG. 4 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” may be interchangeable and include any computer program stored in memory for execution by a processor, including RAM memory, ROM memory, EPROM (erasable programmable read-only memory) memory, EEPROM (electrically erasable programmable read-only memory) memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an embodiment, the system can be executed on a single computer system, without requiring a connection to a server computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a processor; and
a non-transitory computer-readable media storing computing instructions that, when run on the processor, cause the processor to perform operations comprising:
computing a dimension of a product, using a machine learning model trained on text-based training data related to the product, the computing comprising:
transforming preprocessed data into numerical values by at least using a vectorize layer;
condensing the numerical values by at least using an embedding layer;
processing the numerical values, as condensed, by at least using a global average pooling layer;
concatenating the numerical values, as processed, into a layer;
processing the layer using a first dense layer;
standardizing the layer, as processed, by at least using a batch normalization layer;
transforming the layer, as standardized, by at least using an activation function;
regularizing the layer, as transformed, by at least using a dropout function; and
processing the layer, as regularized, with an output layer to compute the dimension of the product.

2. The system of claim 1, wherein the operations further comprise:
training the machine learning model, the training comprising:
providing, for the machine learning model, the text-based training data comprising at least one of:
a product name;
a product description;
a brand name;
a product type;
a product taxonomy;
a numerical feature; or
a product path.

3. The system of claim 2, wherein training the machine learning model further comprises determining a deviation of the dimension of the product, as computed, from an actual dimension of the product.

4. The system of claim 1, wherein the output layer comprises a dense layer with a single neuron for the product.

5. The system of claim 1, wherein the operations further comprise:
preprocessing input data comprising:
tokenizing the input data to create tokens;
identifying a token of the tokens that is not a stop word, is not punctuation, or has a length between 1 and 15 characters from the tokens;
filtering the token, as identified, based on characteristics; and
converting the token, as filtered to lower case text, to generate the preprocessed data.

6. The system of claim 5, wherein preprocessing the input data further comprises:
filtering, from the preprocessed data, data associated with departments that that have less than a predetermined number of data points and outliers.

7. The system of claim 1, wherein the machine learning model comprises a feedforward neural network.

8. The system of claim 1, wherein the activation function comprises a rectified linear unit activation function.

9. The system of claim 1, wherein the dimension of the product, as computed, comprises at least one of:
a predicted length;
a predicted width;
a predicted height; or
a predicted weight.

10. The system of claim 1, wherein the preprocessed data is derived from:
a name of the product;
a description of the product;
a brand name of the product;
a product type of the product;
a product taxonomy of the product;
a numerical feature of the product; and
a product path of the product.

11. A method comprising:
computing a dimension of a product, using a machine learning model trained on text-based training data related to the product, the computing comprising:
transforming preprocessed data into numerical values by at least using a vectorize layer;
condensing the numerical values by at least using an embedding layer;
processing the numerical values, as condensed, by at least using a global average pooling layer;
concatenating the numerical values, as processed, into a layer;
processing the layer using a first dense layer;
standardizing the layer, as processed, by at least using a batch normalization layer;
transforming the layer, as standardized, by at least using an activation function;
regularizing the layer, as transformed, by at least using a dropout function; and
processing the layer, as regularized, with an output layer to compute the dimension of the product;
wherein the dimension of the product, as computed, comprises at least one of:
a predicted length;
a predicted width;
a predicted height; or
a predicted weight.

12. The method of claim 11, further comprising:
training the machine learning model, the training comprising:
providing, for the machine learning model, the text-based training data comprising at least one of:
a product name;
a product description;
a brand name;
a product type;
a product taxonomy;
a numerical feature; or
a product path.

13. The method of claim 12, wherein training the machine learning model further comprises determining a deviation of the dimension of the product, as computed, from an actual dimension of the product.

14. The method of claim 11, wherein the output layer comprises a dense layer with a single neuron of the product.

15. The method of claim 11, further comprising preprocessing input data comprising:
tokenizing the input data to create tokens;
identifying a token of the tokens that is not a stop word, is not punctuation, or has a length between 1 and 15 characters from the tokens;
filtering the token as identified, based on characteristics; and
converting the token, as filtered to lower case text, to generate the preprocessed data.

16. The method of claim 15, wherein preprocessing the input data further comprises:
filtering, from the preprocessed data, data associated with departments that that have less than a predetermined number of data points and outliers.

17. The method of claim 11, wherein the machine learning model comprises a feedforward neural network.

18. The method of claim 11, wherein the activation function comprises a rectified linear unit activation function.

19. The method of claim 11, wherein the preprocessed data is derived from:
a name of the product;
a description of the product;
a brand name of the product;
a product type of the product;
a product taxonomy of the product;
a numerical feature of the product; and
a product path of the product.

20. A non-transitory computer readable storage medium storing a computing instruction that, when run on a processor, cause the processor to perform an operation comprising:
preprocessing input data to generate preprocessed data, the preprocessing comprising:
tokenizing the input data to create tokens;
identifying a token that is not a stop word, punctuation, or having a length between 1 and 15 characters from the tokens;
filtering the token as identified, based on characteristics; and
converting the token, as filtered to lower case text, to generate the preprocessed data; and
computing a dimension of a product, using a machine learning model trained on text-based training data related to the product, the computing comprising:
transforming preprocessed data into numerical values by at least using a vectorize layer;
condensing the numerical values by at least using an embedding layer;
processing the numerical values, as condensed, by at least using a global average pooling layer;
concatenating the numerical values, as processed, into a layer;
processing the layer using a first dense layer;
standardizing the layer, as processed, by at least using a batch normalization layer;
transforming the layer, as standardized, by at least using an activation function;
regularizing the layer, as transformed, by at least using a dropout function; and
processing the layer, as regularized, with an output layer to compute the dimension of the product;
wherein the dimension of the product, as predicted comprises at least one of a:
predicted length;
a predicted width;
a predicted height; or
a predicted weight.
